(19) United States
(12) Patent Application Publication
(10) Pub. No.: US 2019/0010084 A1
(43) Pub. Date: Jan. 10, 2019

(54) Systems and Methods for Bulk Processing Substrate Webs

(71) Applicant: Corning Incorporated, Corning, NY (US)

(72) Inventors: Sean Matthew Garner, Elmira, NY (US); Michael Lesley Sorensen, Waverly, NY (US)

(21) Appl. No.: 15/753,885

(22) PCT Filed: Aug. 19, 2016
(86) PCT No.: PCT/US16/47733

§ 371 Date: Feb. 20, 2018

Related U.S. Application Data
(60) Provisional application No. 62/208,266, filed on Aug. 21, 2015.

(51) Int. Cl. C03C 21/00; C03C 15/00; C03C 17/32; B65H 18/28; B65H 37/00

(52) U.S. Cl. CPC C03C 21/005; C03C 15/00; C03C 21/007; B65H 2801/61; B65H 18/28; B65H 37/00; B65H 2301/4127; C03C 17/32

(57) ABSTRACT

Systems and methods for batch processing glass substrate webs are disclosed. In one embodiment, a method of processing a glass substrate web includes applying a spacer layer to at least one of a first surface or a second surface of the glass substrate web, and rolling the spacer layer and the glass substrate web to form a spool. The spacer layer is configured such that a gap exists between the first surface and the second surface of the glass substrate web within the spool. The method further includes applying a fluid to the spool such that the fluid surrounds the spool and is disposed within the gap between the first surface and the second surface within the spool.

This application claims the benefit of priority to U.S. Application No. 62/208,266 filed on Aug. 21, 2015, the content of which is incorporated herein by reference in its entirety.

### BACKGROUND

### Field

The present specification generally relates to the processing of flexible substrate webs and, more particularly, to the bulk processing of flexible substrate webs in spool form.

### Technical Background

Flexible substrates, such as flexible glass substrates, are becoming increasingly popular due at least in part to their thinness, low weight, and strength. Such flexible substrates may be incorporated into many products, such as personal electronics, appliances, architectural components, and the like. The production of articles from glass substrates may require processes that are quite long in duration. Antimicrobial glasses are an example of an application for a glass that has found its way into personal electronic devices, public kiosks, lavatory fixtures, and the like. Antimicrobial glass may be formed by including silver ions, which have been shown to kill bacteria, in the glass substrate. However, inclusion of silver ions in a glass substrate by an ion exchange process generally requires submerging the glass substrate in an ion exchange bath for a lengthy duration (e.g., two days). Such a lengthy cycle time can make it impractical to process large numbers of glass substrate articles having antimicrobial properties.

Accordingly, there exists a need for systems and methods of processing a large surface area of glass substrates to increase volume throughput.

### SUMMARY

In one embodiment, a method of processing a glass substrate web includes applying a spacer layer to at least one of a first surface or a second surface of the glass substrate web, and rolling the spacer layer and the glass substrate web to form a spool. The spacer layer is configured such that a gap exists between the first surface and the second surface of the glass substrate web within the spool. The method further includes applying a fluid to the spool such that the fluid surrounds the spool and is disposed within the gap between the first surface and the second surface within the spool.

In another embodiment, a method of processing a glass substrate web includes applying a spacer layer to at least one of a first surface or a second surface of the glass substrate web. The glass substrate web includes a first edge and a second edge opposite the first edge. The spacer layer includes a first plurality of spacer segments positioned proximate the first edge of the glass substrate web, a second plurality of spacer segments positioned proximate the second edge of the glass substrate web, and a third plurality of spacer segments positioned on a central region of at least one of the first surface or the second surface of the glass substrate web. The method further includes rolling the spacer layer and the glass substrate web around a central core to form a spool. The spacer layer is configured such that a gap exists between the first surface and the second surface of the glass substrate web within the spool. A fluid is applied to the spool such that the fluid surrounds the spool and is disposed within the gap between the first surface and the second surface within the spool.

In yet another embodiment, a glass substrate web processing system includes a glass substrate web spool, an enclosure, and a fluid within the enclosure. The glass substrate web includes a first surface and a second surface, and a spacer layer applied to at least one of the first surface or the second surface. The glass substrate web and the spacer layer are rolled into a spool such that a gap exists between the first surface and the second surface of the glass substrate web within the spool. The fluid is provided within the enclosure such that it surrounds the glass substrate web and is disposed within the gap between the first surface and the second surface within the spool.

In yet another embodiment, a method of processing a glass substrate web includes applying a fluid to a spool of the glass substrate web. The spool includes a spacer layer disposed between adjacent windings of the spool to form a gap therebetween. During the applying step, the fluid is disposed within the gap.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the representative embodiments.

FIG. 1A is a schematic illustration of a spool comprising a substrate web and a spacer layer wound around a central core according to one or more embodiments described and illustrated herein;

FIG. 1B is a schematic illustration of a substrate web and a spacer layer in the process of being wound onto a central core according to one or more embodiments described and illustrated herein;

FIG. 1C is a schematic illustration of a close-up view of the spool depicted in FIG. 1A according to one or more embodiments described and illustrated herein;

FIG. 1D is a schematic illustration of a flexible glass web according to one or more embodiments described and illustrated herein;

FIG. 1E is a schematic illustration of a polymer film web with discrete flexible glass pieces adhered thereto according to one or more embodiments described and illustrated herein;

FIG. 2A is a schematic illustration of a top-down view of a spacer layer applied to a substrate web according to one or more embodiments described and illustrated herein;

FIG. 2B is a schematic illustration of an end view of the spacer layer and substrate web depicted in FIG. 2A according to one or more embodiments described and illustrated herein;

FIG. 3 is a schematic illustration of an end view of an alternative spacer layer applied to a substrate web according to one or more embodiments described and illustrated herein;

FIG. 4 is a schematic illustration of a top-down view of an alternative spacer layer applied to a substrate web according to one or more embodiments described and illustrated herein;

FIG. 5 is a schematic illustration of a top-down view of an alternative spacer layer applied to a substrate web according to one or more embodiments described and illustrated herein;

FIG. 6 is a schematic illustration of a top-down view of an alternative spacer layer applied to a substrate web according to one or more embodiments described and illustrated herein;

FIG. 7 is a schematic illustration of a top-down view of an alternative spacer layer applied to a substrate web according to one or more embodiments described and illustrated herein;

FIG. 8 is a schematic illustration of a top-down view of a spacer layer and a mask layer applied to a substrate web according to one or more embodiments described and illustrated herein;

FIG. 9A is a schematic illustration of a system for processing a substrate web according to one or more embodiments described and illustrated herein; and

FIG. 9B is a schematic illustration of a spool of a substrate web disposed in a fluid within an enclosure according to one or more embodiments described and illustrated herein.

### DETAILED DESCRIPTION

The embodiments disclosed herein relate to the batch processing of a spool of a wound flexible substrate web. Particularly, a length of a substrate web, such as a glass web, is wound with an interleaf or spacer layer into a spool assembly. The spacer layer provides a gap between adjacent surfaces of the substrate web to allow a fluid, such as a gas or liquid, to pass therethrough and contact a portion of a surface area of the surfaces of the substrate web. The spool of substrate web and a spacer layer may be bulk processed to perform processes such as, without limitation, ion exchanging, chemical etching, and coating layer deposition. Because the substrate web is in spool form, large lengths of the substrate web may be processed at once, which may be particularly beneficial for processes having a large duration time.

Various methods for bulk processing substrate webs and systems for processing substrate webs are described in detail below.

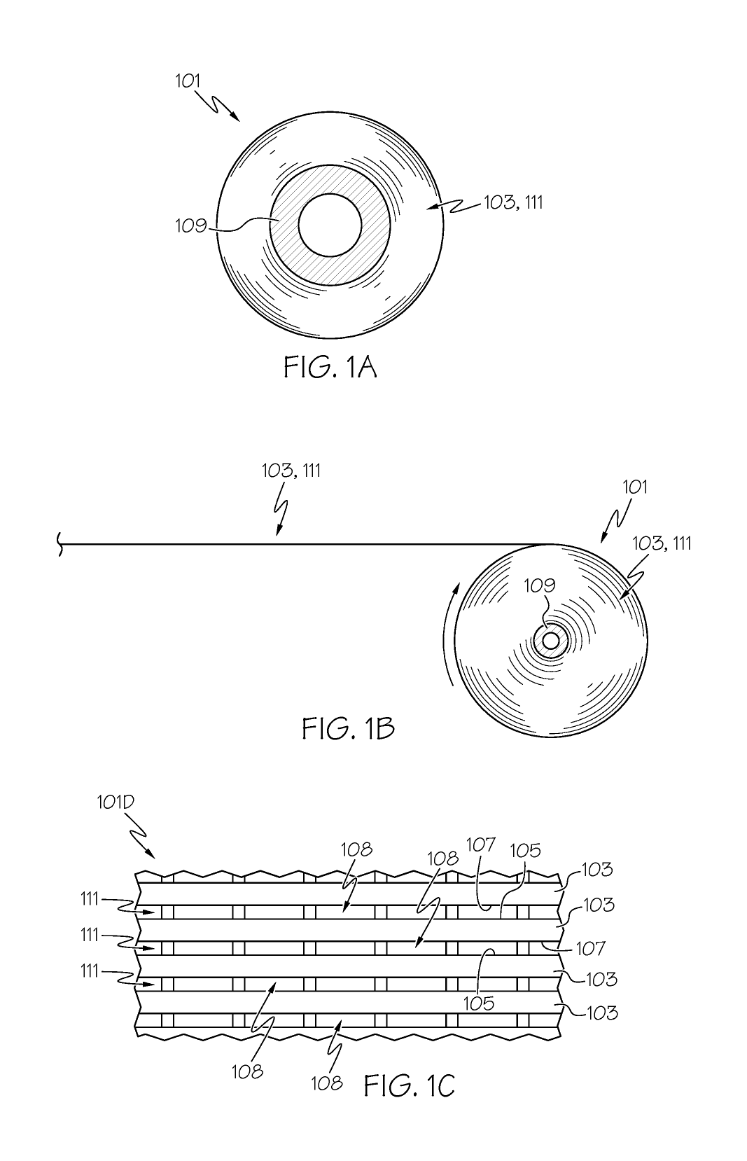

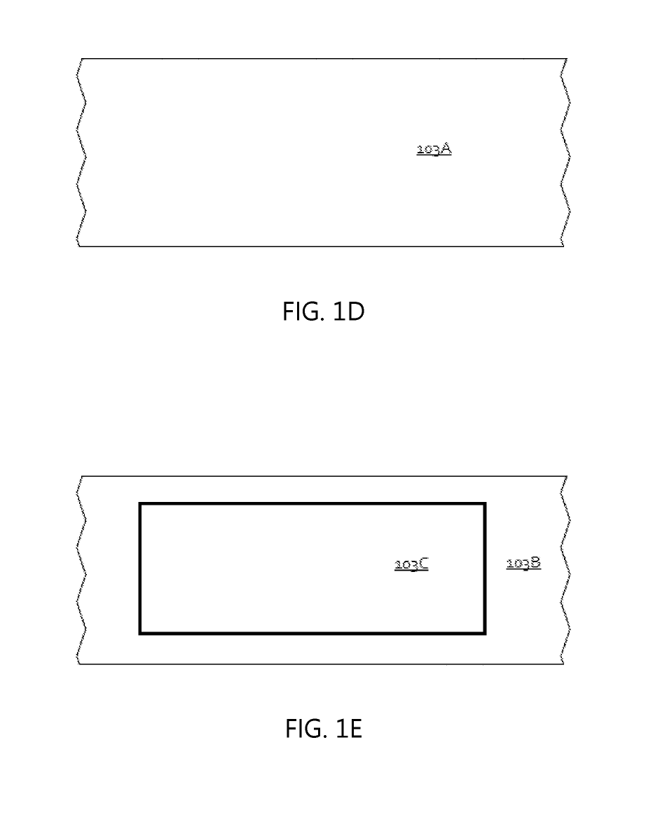

Referring now to FIGS. 1A-1C, an example spool 101 comprises a rolled substrate web 103 and a spacer layer 111. Particularly, FIG. 1A schematically illustrates a top-down view of the example spool 101, FIG. 1B schematically illustrates a process of rolling the substrate web 103 and the spacer layer 111 into the example spool shown in FIG. 1A, and FIG. 1C schematically illustrates a close-up view of the spool 101 shown in FIG. 1A. As shown in FIG. 1C and described in more detail herein, the spacer layer 111 provides a gap 108 between adjacent surfaces of the substrate web 103 within the spool 101 to allow a fluid to contact a portion of the two surfaces of the substrate web 103. It should be understood that the substrate web 103 and the spacer layer 111 are not individually depicted in FIGS. 1A and 1B for ease of illustration. Further, it should also be understood that FIG. 1A is a simplified schematic illustration of an example spool 101, and that the spool 101 may include many individual turns of the substrate web 103 and the spacer layer 111.

As used herein, the term “substrate web” means a glass substrate web comprising at least one of a glass material, a ceramic material, or a glass-ceramic material. In some embodiments, the substrate web comprises one or more of polymer or metal materials. For example, the substrate web can comprise a flexible glass web (e.g., a continuous web of flexible glass material) that is capable of being wound into a spool. FIG. 1D schematically illustrates one embodiment of a flexible glass web 103A. Also for example, different materials may be spliced, laminated, or joined together to create a spool. As an example, the substrate web can include a polymer film web that has discrete flexible glass pieces permanently or temporarily adhered thereto (e.g., to a surface of the polymer film web). FIG. 1E schematically illustrates one embodiment of a polymer film web 103B comprising discrete flexible glass pieces 103C adhered thereto. In some embodiments, the polymer film web comprises openings aligned with one or more of the discrete flexible glass pieces such that both first and second surfaces of the flexible glass pieces are exposed for applying a fluid thereto as described herein. The different materials can each cover the entire width of the web or be individual discrete regions. As non-limiting examples, EagleXG®, Lotus®, and Gorilla® Glass substrates fabricated by Corning Incorporated of Corning, N.Y. may be processed using the methods described herein. As another non-limiting example, flexible yttria-stabilized zirconia may be processed using the methods described herein.

The substrate web 103 should have a thickness such that it is capable of being rolled into a spool, as shown in FIGS. 1A-1C. In the case of a glass substrate, as a non-limiting example, the substrate web 103 may have a thickness of less than 300 μm. It should be understood that the substrate web 103 may take on other thicknesses depending on the composition and properties of the material. For example, the thickness of the substrate web can be 200 um or less, 150 um or less, 100 um or less, or 50 um or less. Additionally, or alternatively, the substrate web can have a width suitable for the application requirements that may range from 10 mm to >1 m. For example, the width of the substrate web can be 100 mm or greater, 300 mm or greater, 500 mm or greater, 1000 mm or greater, 2000 mm or less, 1500 mm or less, or 1000 mm or less. Additionally, or alternatively, the substrate web can have a length in a range from <1 m to >1000 m depending on the application requirements. For example, the length of the substrate web can be 1 m or greater, 50 m or greater, 100 m or greater, 200 m or greater, 300 m or greater, 2000 m or less, 1000 m or less, or 500 m or less. The substrate may also have through-via holes that enable flow of the fluid from one side of the substrate to the next.

As described in more detail below, the spacer layer 111 is coupled to at least one surface of the substrate web 103. Referring to FIG. 1B, after the spacer layer 111 is secured to the substrate web 103, the assembly is mechanically rolled into a spool 101. In some embodiments, the spacer layer 111 and the substrate web 103 are rolled onto a center core 109. The center core 109, which acts as a support for the spool 101, may be made of a chemically inert material capable of being subjected to a fluid, such as the ion exchange solutions and/or chemical etching solutions described below. The spacer layer 111 should also be made of a chemically inert material. The spacer layer 111 and substrate web 103 may be rolled into the spool 101 by any known or yet-to-be-developed rolling process.

Referring now to FIG. 1C, the spacer layer 111 is configured to provide a gap 108 between a first surface 105 and a second surface 107 of the substrate web 103. For example, the spool 101 comprises a series of windings or wrappings of the substrate web 103, and the gap 108 is disposed between the first surface 105 of a first wind of the spool and the second surface 107 of a second winding of the spool adjacent to the first winding. Each winding can be formed by wrapping the substrate web 103 one revolution around the spool. The gap 108 allows a fluid (i.e., a gas or a liquid) to flow between the first and second surfaces 105, 107. In this manner, the fluid may flow through the spool 101 such that it contacts a portion of the surface area of the first surface 105 and the second surface 107. The gap 108 should have a width large enough to allow the fluid to flow therethrough. As an example and not a limitation, the width of gap 108 may be 10 um to 1 mm. The specific dimension chosen depends on the process conditions and processing that is intended. The spacer layers described herein may be made from a material that is impervious to the fluid utilized to process the substrate web 103. Non-limiting examples of materials for the spacer layer include Teflon or polyimide. It should be understood that other materials may be utilized.

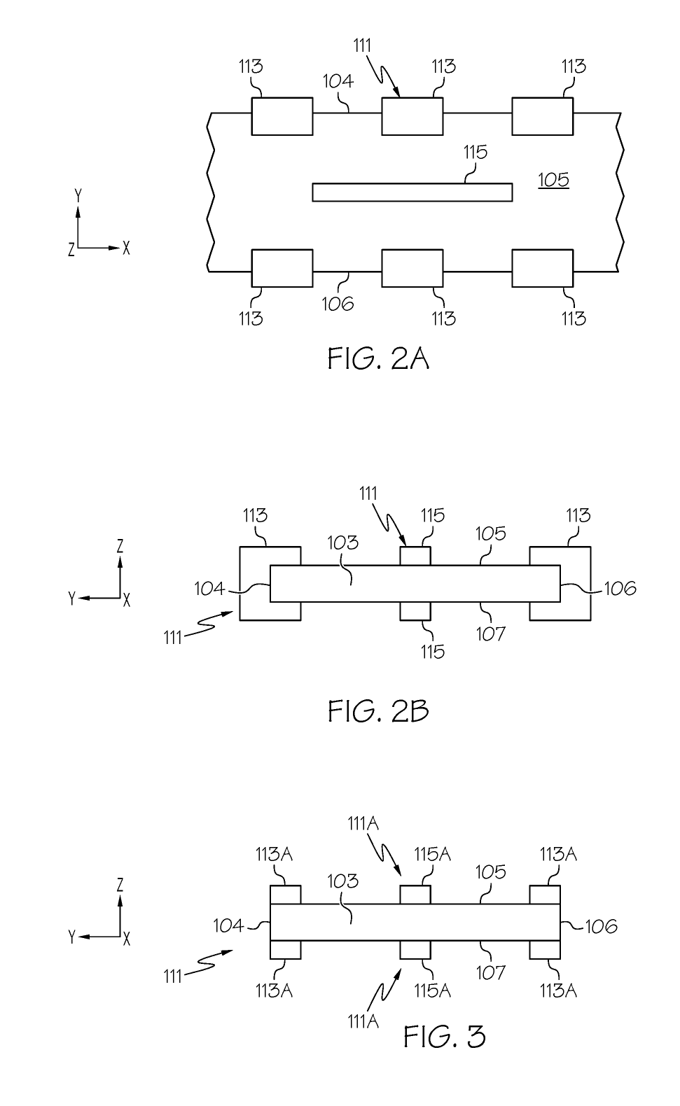

An example spacer layer 111 will now be described with reference to FIGS. 2A and 2B. FIG. 2A is a top-down view of the first surface 105 of the substrate web 103, while FIG. 2B is an end view. It should be understood that embodiments are not limited to the configuration and placement of the spacer layer 111 with respect to the substrate web 103. In the illustrated embodiment, the spacer layer 111 comprises a plurality of spacer segments 113 on the first and second surfaces 105, 107 of the substrate web 103 proximate first and second edges 104, 106. For example, the spacer segments may be disposed within about 10 mm, within about 5 mm, or within about 2 mm of the first and second edges 104, 106. As shown in FIG. 2B, the plurality of spacer segments 113 positioned along the first and second edges 104, 106 are generally “U” shaped such that they wrap around the edges 104, 106 of the substrate web 103 from the first surface 105 to the second surface 107. Spacer segments 113 positioned proximate the first and second edges 104, 106 may be aligned (e.g., in the y direction) with one another as shown in FIG. 2A. Alternatively, spacer segments positioned proximate the first and second edges 104, 106 may be misaligned with one another.

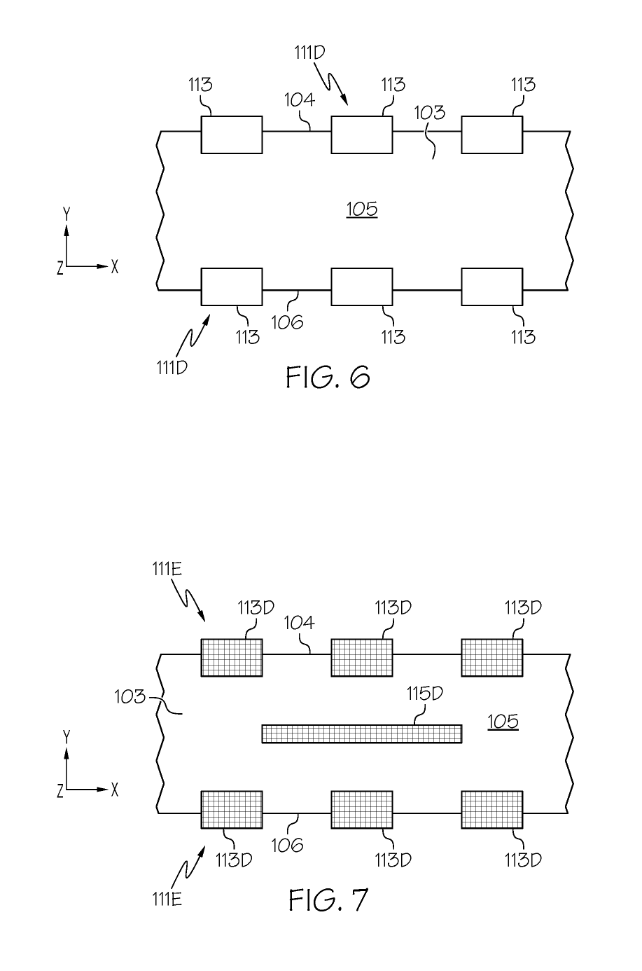

The spacer layer 111 may further include a plurality of spacer segments 115 positioned along a central region (e.g., a centerline) of the substrate web 103 as shown in FIGS. 2A and 2B. These center spacer segments 115 may be provided to prevent sagging of the substrate web 103 near its middle. It should be understood that the center spacer segments 115 may not be utilized in other embodiments (see FIG. 6). Additionally, the center spacer segments may be positioned along the center line as shown in FIGS. 2A and 2B or spaced away or offset from the centerline. Spacer segments 115 may be aligned or misaligned (e.g., in they direction) with spacer segments 113.

The spacer layer 111 may be applied to the substrate web 103 by any suitable process. For example, the substrate web 103 may be inserted into the spacer layer 111 by an automated mechanical process. The spacer layer 111 may be adhered to the substrate web 103 by use of an adhesive in embodiments. The spacer layer 111 may be a non-adhered interleaf material or an adhered laminate or coating. The spacer layer 111 may also be part of the overall substrate web 103 itself and not an additional element that is added or combined with the substrate web 103 (i.e., web edge beads).

The spacer layer 111 may take on many other shapes and configurations other than as is illustrated in FIGS. 2A and 2B. For example, rather than a plurality of spacer segments 113 the spacer layer 111 may be continuous along the first and second edges 104, 106 of the substrate web 103. Further, the spacer layer 111 may have a continuous strip positioned within a center of substrate web 103 on the first and second surfaces 105, 107 rather than a plurality of spacer segments 115 as shown in FIGS. 2A and 2B. In still other embodiments, the spacer layer 111 may be applied to only one of the first and second surfaces 105, 107 of the substrate web 103. In still other embodiments, the spacer layer may be a continuous or substantially continuous layer of permeable material to enable a fluid to flow through the spacer material as described herein.

In some embodiments, the spacer layer can prevent fluid from contacting regions of the substrate web covered by the spacer layer during processing of the substrate web as described herein. Thus, it may be beneficial to minimize the surface area of the substrate web covered by the spacer layer while maintaining the gap within the spool. In some embodiments, the region of the substrate web covered by the spacer layer is at most about 20%, at most about 10%, or at most about 5% of a total surface area of the substrate web.

Referring now to FIG. 3, another example spacer layer 111A is shown applied to first and second surfaces 105, 107. The illustrated spacer layer 111A has a plurality of spacer segments 113A positioned on the first and second surface 105, 107 proximate the first and second edges 104, 106. The illustrated spacer layer 111A also includes a plurality of spacer segments 115A disposed along a centerline on the first and second surfaces 105, 107 of the substrate web 103. However, in the embodiment illustrated in FIG. 3, the plurality of spacer segments 113A do not fully wrap around the first and second edges 104, 106 as illustrated in FIGS. 2A and 2B and they may be formed some distance away from the first and second edges 104, 106. Rather, the spacer segments 113A are positioned only on the first and second surface 105, 107. As stated above with respect to FIGS. 2A and 2B, the spacer layer 111A may not include the center spacer segments 115A and/or may only be disposed on one of the first and second surfaces 105, 107.

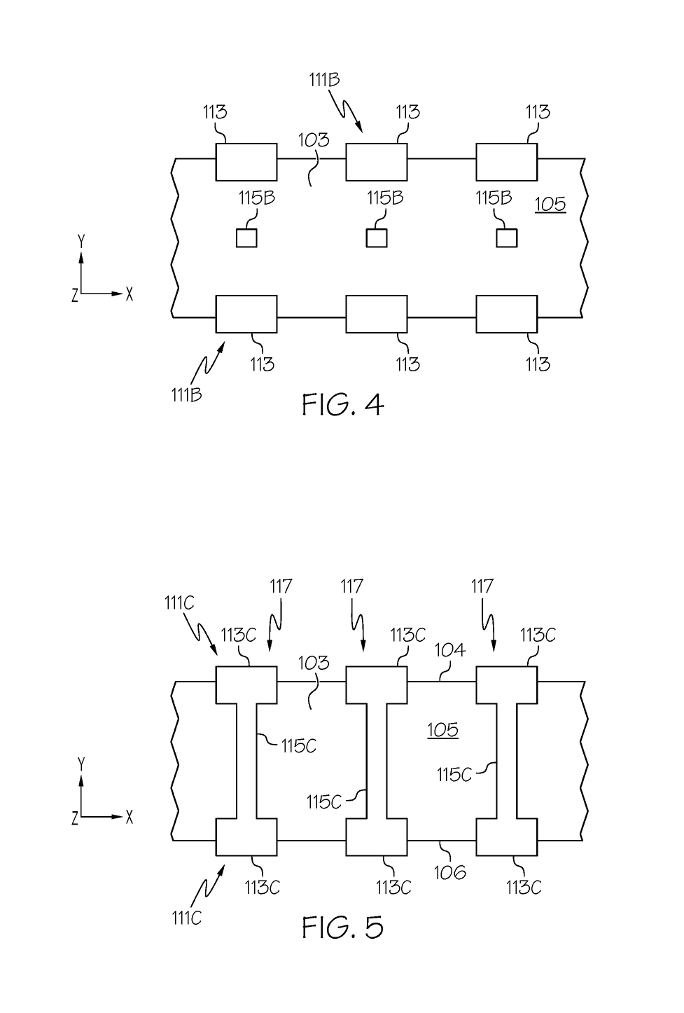

FIG. 4 illustrates an example spacer layer 111B wherein the plurality of spacer segments 115B positioned along a centerline of the substrate web 103 are shorter in length than the those depicted in FIGS. 2A and 2B. The center spacer segments 115B are generally aligned with the edge spacer segments 113 along the y-axis as shown in FIG. 4. The spacer layer 111B may be disposed on one or both surfaces 105, 107 of the substrate web 103. It is noted that the center spacer segments 115B may be formed in various patterns and configurations and do not need to exist in a line down the center of the substrate web 103.

Referring now to FIG. 5, another example embodiment of a spacer layer 111C is illustrated. The spacer layer 111C depicted in FIG. 5 comprises a plurality of integrated spacer segments 117 disposed on at least one surface 105, 107 of the substrate web 103. Each integrated spacer segment 117 comprises two edge portions 113C proximate first and second edges 104, 106 of the substrate web 103, and a center portion 115C extending between the two edge portions 113C. The two edge portions 113C may fully wrap around first and second edges 104, 106, or they may be only positioned on the first and/or second surfaces 105, 107 without wrapping around the edges (see FIG. 3). The center portion 115C of the integrated spacer segments 117 may prevent the substrate web 103 from sagging in the middle when rolled into the spool 101. The center portion 115C may serve as a mask to prevent fluid from contacting a region of the substrate web covered by the center portion. For example, the non-contacted region of the substrate web may be a non-strengthened region (e.g., because no ion exchange takes place at the non-contacted region) at which the substrate web can be cut after processing.

FIG. 6 schematically depicts an example spacer layer 111D wherein no segments are disposed in the middle of the substrate web 103, as stated above.

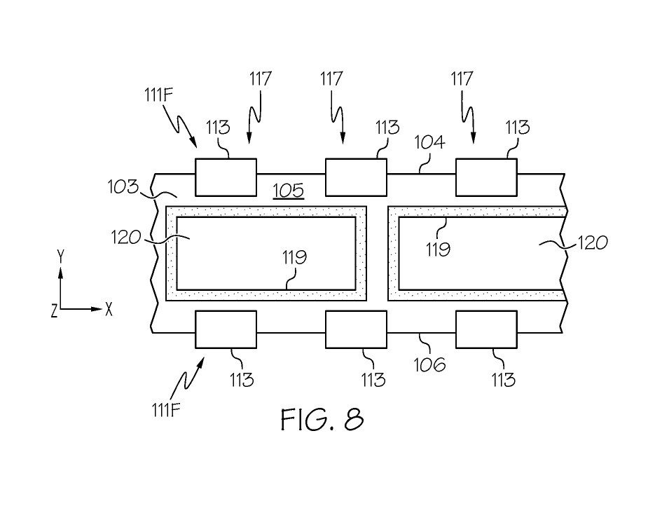

In some embodiments, the spacer layer may be permeable, such that fluid may flow through the spacer layer and contact the surfaces of the substrate web. For example, the spacer layer may be made of a porous or mesh material, and/or have channels disposed therein. Referring now to FIG. 7, another example substrate layer 111E is schematically illustrated. The example substrate layer 111E has a configuration similar to the embodiment depicted in FIG. 2A. The spacer segments 113D, 115D are configured as a mesh providing channels or spaces through which the fluid may pass and contact the first and/or second surfaces 105, 107. The substrate layer 111E may also be made of a porous material rather than configured as a mesh in other embodiments.

In other embodiments, the spacer layer may be configured to confine fluid contact or interaction with the substrate web 103 in an area only at and/or proximate the first and second edges 104, 106 (i.e., edge faces). For example, the spacer layer may be configured as two continuous strips disposed on an interior region of the first and/or second surface of the substrate web 103 such they are offset from the first and second edges 104, 106. The continuous strips of the spacer layer confine the area of fluid contact to only the first and second edges 104, 106 and an area on the first and second surfaces 105, 107 proximate the first and second edges 104, 106. For example, the continuous strips can be spaced away from the first and second edges by at least about 10 mm, at least about 15 mm, or at least about 20 mm. Thus, the fluid is prevented from entering a central portion of the gap disposed between the continuous strips of the spacer layer such that at least a portion of the central region of the substrate web disposed between the continuous strips of the spacer layer is not contacted by the fluid.

It should be understood that spacer layer may take on configurations different from those illustrated in FIGS. 2A-7. The purpose of the spacer layer is to create the required flow channels to enable interaction of the fluid with the first and/or second surface 105, 107 of the substrate web.

Referring now to FIG. 8, a mask material 119 may be permanently or removably disposed on one or more surfaces 105, 107 of the substrate web 103. The mask material 119, which may be provided in any desired pattern, prevents the fluid from reaching the portion of the surface of substrate web 103 covered by the mask material. In the illustrated embodiment, the mask material 119 is disposed between the spacer segments 113 of the spacer layer 111F to define a plurality of rectangular shapes 120 on the surface 105 of the substrate web 103 that is not covered by the mask material 119. As an example and not a limitation, the rectangular shapes 120 may be glass or polymer panels or frames that will be severed from the substrate web 103, and the mask material 119 may prevent a glass strengthening ion exchange bath from reaching the portion of the surface 105 covered by the mask material, thereby providing a non-strengthened region corresponding to the mask material by which to more easily cut the rectangular shapes from substrate web 103.

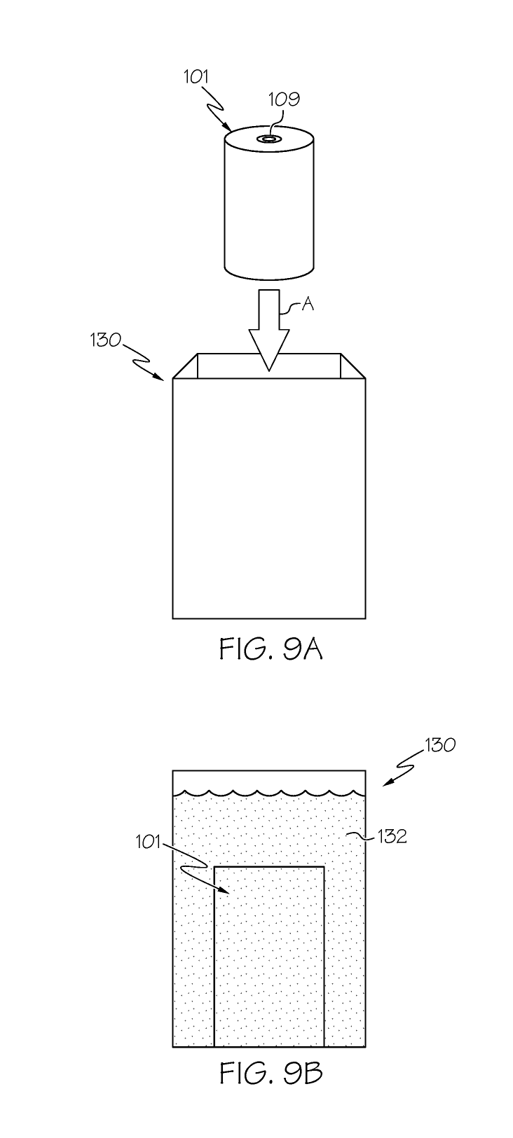

Embodiments of the present disclosure enable batch processing of an entire spool 101 of a substrate web 103 rather than processing individual severed pieces of the substrate web 103, or requiring the spool to be unwound to further process the substrate web 103. Referring now to FIG. 9A, after the substrate web 103 and the spacer layer 111 are rolled into the spool 101 as shown in FIGS. 1A-1C, the spool 101 is disposed in an enclosure 130 as illustrated by arrow A. The enclosure 130 may be configured as any structure (e.g., a vessel, tank, or chamber) configured to apply a fluid to the spool 101 such that fluid passes through the gaps 108 within the spool 101 and contacts a portion of the surface area of the first and second surfaces 105, 107. For example, where the fluid is a gas, the enclosure 130 may be a component of a larger system including nozzles capable of filling the enclosure 130 with the gas. As another example, where the fluid is a liquid, the enclosure 130 should be capable of maintaining the liquid such that it surrounds the spool 101. The composition of the substrate web 103 is chosen to be compatible with the intended process. It is noted that the fluid does not need to completely surround the spool 101 or contact all of the layers of the substrate web 103. The enclosure 130 should direct the fluid to contact at least a portion of the substrate web 103 first or second surfaces 105, 107. The enclosure 130 may also produce agitation (e.g., mechanical, ultrasonic or other), oscillating flow of the fluid, flow of multiple fluids in sequence, heat, or other conditions required to perform the desired surface processing of the substrate web 103.

In some embodiments, applying the fluid to the spool includes flowing the fluid over the spool (e.g., by spraying the fluid onto the spool) such that the fluid flows into the gaps within the spool to contact at least one of the first surface or the second surface of the substrate web. The fluid can be flowed over the spool instead of or in addition to submerging the spool into a bath of the fluid as described herein.

Referring now to FIG. 9B, a spool 101 disposed within an enclosure 130 containing a fluid 132 is schematically illustrated. In the illustrated embodiment, the fluid 132 is illustrated as a bath. For example, the bath may be an aqueous bath or a molten salt bath. As an example and not a limitation, the bath may provide for an ion exchange process, such as an ion exchange process to create an antimicrobial glass or an ion exchange process to create a chemically strengthened glass. Thus, the bath may be a molten salt bath comprising first ions to be exchanged with second ions in the substrate web. It is noted that ion exchange processes may require an alkali containing glass material to successfully exchange ions between the glass material and the ion exchange bath.

Antimicrobial glass substrates have become popular in recent years, and may be incorporated in a wide variety of products, such as consumer electronics products. In embodiments described herein, silver ions (Ag⁺), which have shown a high bacteria kill rate, are provided in an aqueous solution of silver nitrate 132 and are exchanged with ions of an alkali containing glass web 103 rolled in a spool 101. The spool 101 with a spacer layer 111 allows the aqueous solution 132 to come into contact with the surfaces of the glass web 103 even though it is rolled into a spool 101. Because of the long soak times that may be required for the ion exchange process to provide for inclusion of the silver ions into the glass substrate, batch processing of an entire spool 101 has an advantage over a slow roll-to-roll process or a similarly slow processing of individual sheets. In other words, embodiments described herein enable preparation of a larger surface area of antimicrobial glass in the same amount of time that it takes to produce a small pre-cut run of antimicrobial glass. This reduces the total amount of process time per individual piece of antimicrobial cut from the glass web 103, as well as provides for a large volume throughput.

In additional to batch processing antimicrobial glass, embodiments described herein may also provide for batch processing of chemically strengthened glass by an ion-exchange process. The fluid 132 is any known or yet-to-be-developed aqueous bath capable of forming compressive stress layers extending from the first and second surface 105, 107 into the bulk of the glass web 103. For example, the fluid 132 may comprise potassium ions that are exchanged with sodium ions of the glass web 103. Batch processing of an entire spool 101 of the glass web 103 provides for a large volume throughput of chemically strengthened glass articles.

Other non-aqueous fluid processing of the substrate web 103 is also possible, but the substrate web 103 and any spacer materials should be chosen to have suitable thermal, chemical, and other process compatibilities. For example, to enable fluid processing of a substrate web 103 using a molten salt bath (e.g., comprising Ag⁺ ions for antimicrobial ion exchange and/or K⁺ ions for chemical strengthening), the spacer material can be compatible with the typical >300° C. process temperatures.

The fluid 132 may also be an etchant solution operable to chemically etch the substrate web 103 while in spool form. As an example and not a limitation, the substrate web 103 may be configured as a thin alkali-containing or alkali-free glass substrate having laser drilled vias formed by a laser drilling process that is upstream from the rolling process depicted in FIG. 1B. Such vias may be useful in glass interposers for use in electronic devices. An example laser drilling process is described in U.S. Patent Application No. 62/208,282, titled “Methods of Continuous Fabrication of Features in Flexible Substrate Webs and Products Relating to the Same,” which is incorporated herein by reference in its entirety. The laser-drilled vias are areas of the glass web 103 that have been damaged by a laser beam. Glass material damaged by the laser beam is removed faster by the etchant solution than the non-laser damaged areas. In this manner, the etchant solution may be operable to remove glass material to open up the laser drilled vias to a desired diameter. This example illustrates that it is possible to perform continuous roll-to-roll processing with the substrate web 103 either before or after the batch processing steps performed by enclosure 130.

The chemical etchant solution may be any solution capable of chemically etching material from the substrate web rolled in the spool 101. Example non-limiting chemical etchant solutions include a hydrofluoric acid (HF) solution and a potassium hydroxide (KOH) solution. A KOH etch process may produce vias with straighter sidewalls than a HF etch process. However, such a KOH etch process may require a two day etch process. The batch processing enabled by the embodiments described herein make a KOH etch process more practical because more surface area of the glass substrate may be processed at one time while it is in spool form. As another example, the spacer layer may only enable contact of the fluid to the substrate web surfaces near the edges. In this case, for example, a fluidic etching process may occur only at the edge faces of the substrate web and the surfaces near the edges. This example enables fluidic edge finishing of the substrate web to occur in a batch process. In this case, the spacer layer function and the masking layer function may be combined into a single material.

In another embodiment, the fluid 132 is operable to remove a photoresist layer present on the first and/or second surface 105, 107 of the substrate web 103 while it is rolled in a spool 101. Other types of layers may also be removed by the working 132 fluid while the substrate web is rolled into the spool 101.

Other batch processes are also possible. In addition to chemical etching and ion exchange processes, one or more coating layers may be deposited on the surfaces of the substrate web 103 by either gas or liquid processing. For example, one or more thin film layers (e.g., polymer layers) may be deposited on the surfaces of the substrate web 103 while rolled in the spool 101. Also, the fluid batch processing of the substrate web 103 spool can be used to surface treat either the first or second surface 105, 107. As another non-limiting example, the fluid may be configured to change the surface energy of at least a portion of the first and second surfaces 105, 107 of the substrate web 103. Silane gas and ozone gas are non-limiting examples of fluids capable of surface energy modification.

### Example

A 100 mm×300 mm substrate of 50 μm thick Corning code 2318 glass fabricated by Corning Incorporated of Corning, N.Y. and a spacer layer having the geometry of FIGS. 2A and 2B was wound around a Teflon® core into a spool. The spool was secured with Kapton tape on the outside to prevent unwinding. The spacer layer provided a gap of within the range of 100-150 um between adjacent surfaces of the glass.

The entire spool was submerged in an aqueous solution of 13M silver nitrate (0.5328 g in 240 ml deionized water) at 95° C. for 96 hours. After the ion exchange process, the entire spool was rinsed while still in spool form. The glass was then unrolled, and samples were removed from different layers of the spool to test for antimicrobial efficacy as well as for physical property testing, such as UV-visible light transmission. The glass demonstrated an antimicrobial kill rate of about log 2.5, while showing no appreciable diminishing of optical clarity or visible light transmission. This evaluation confirms that batch processing of both the first and second surface of the substrate web occurred while wound in a spool configuration.

It should now be understood that embodiments of the present disclosure enable the processing of an entire spool of a substrate web, such as a glass web, in batch mode. This enables performing various processes on a length of a substrate web that are too long in duration to be practical for roll-to-roll or piecemeal processing. Further, the embodiments described herein enable processes to be performed on large areas of a flexible substrate that would not be practical in sheet form unless a carrier is used. Use of a carrier, it is noted, limits access to only one surface of the substrate at a time. Accordingly, embodiments described herein increase volume throughput, and enable the practical processing of large surface areas of substrate webs using processes that have a long duration time.

While exemplary embodiments have been described herein, it will be understood by those skilled in the art that various changes in form and details may be made therein without departing from the scope encompassed by the appended claims.

1. A method of processing a glass substrate web, the method comprising:
applying a fluid to a spool of the glass substrate web;
wherein the spool comprises a spacer layer disposed between adjacent windings of the spool to form a gap therebetween; and
wherein during the applying step, the fluid is disposed within the gap.

2. The method of claim 1, further comprising:
applying the spacer layer to at least one of a first surface or a second surface of the glass substrate web; and
rolling the spacer layer and the glass substrate web to form the spool, the spacer layer configured such that the gap exists between the first surface and the second surface of the glass substrate web within the spool.

3. (canceled)

4. The method of claim 1, wherein the spacer layer comprises a permeable material that is permeable to the fluid.

5. The method of claim 1, wherein the glass substrate web comprises a continuous web of flexible glass material.

6. The method of claim 1, wherein the glass substrate web comprises a polymer film web and a plurality of discrete flexible glass pieces.

7. (canceled)

8. The method of claim 1, wherein:
the glass substrate web comprises a first edge and a second edge opposite the first edge; and
the spacer layer is applied to at least one of the first surface or the second surface proximate the first edge and the second edge.

9. The method of claim 1, wherein:
the glass substrate web comprises a first edge and a second edge opposite the first edge; and
the spacer layer comprises a first plurality of spacer segments positioned proximate the first edge of the glass substrate web and a second plurality of spacer segments positioned proximate the second edge of the glass substrate web.

10. The method of claim 9, wherein the glass substrate web further comprises a third plurality of spacer segments positioned at a central region of at least one of the first surface or the second surface of the glass substrate web.

11. (canceled)

12. The method of claim 2, further comprising, prior to rolling the glass substrate web, applying a mask layer to at least a portion of at least one of the first surface or the second surface of the glass substrate web.

13. The method of claim 1, wherein fluid contact with the glass substrate web is confined to substrate edge faces and an area proximate the substrate edge faces on a first surface or a second surface of the glass substrate web.

14. The method of claim 1, wherein the fluid comprises a hydrofluoric acid etchant solution operable to chemically etch the glass substrate web of the spool.

15. The method of claim 1, wherein the fluid comprises a potassium hydroxide etchant solution operable to chemically etch the glass substrate web of the spool.

16. The method of claim 1, wherein the fluid is configured to change a surface energy of at least a portion of the first surface or the second surface of the glass substrate web.

17. The method of claim 1, wherein the fluid comprises a gas.

18. The method of claim 17, wherein the gas creates a thin film layer on at least one of the first surface or the second surface of the glass substrate web.

19. The method of claim 1, wherein the fluid comprises an aqueous solution of silver nitrate operable to incorporate silver ions into the glass substrate web.

20. The method of claim 1, wherein the fluid comprises an aqueous solution operable to exchange ions with the glass substrate web to form a first compressive stress layer extending from a first surface into a bulk of the glass substrate web and a second compressive stress layer extending from a second surface into the bulk of the glass substrate web.

21. The method of claim 1, wherein the fluid comprises a polymer operable to form a first polymer layer on the first surface of the glass substrate web or a second polymer layer on the second surface of the glass substrate web.

22. A method of processing a glass substrate web, the method comprising:
applying a spacer layer to at least one of a first surface or a second surface of the glass substrate web, wherein:
the glass substrate web comprises a first edge and a second edge opposite the first edge; and
the spacer layer comprises a first plurality of spacer segments positioned proximate the first edge of the glass substrate web, a second plurality of spacer segments positioned proximate the second edge of the glass substrate web, and a third plurality of spacer segments positioned on a central region of at least one of the first surface or the second surface of the glass substrate web;
rolling the spacer layer and the glass substrate web around a central core to form a spool, wherein the spacer layer is configured such that a gap exists between the first surface and the second surface of the glass substrate web within the spool; and
applying a fluid to the spool such that the fluid surrounds the spool and is disposed within the gap between the first surface and the second surface within the spool.

23. The method of claim 22, wherein the fluid comprises at least one of:
a chemical etchant solution operable to chemically etch the glass substrate web of the spool; or
an aqueous solution of silver nitrate operable to incorporate silver ions into the glass substrate web; or
an aqueous solution operable to exchange ions with the glass substrate web to form a first compressive stress layer extending from the first surface into a bulk of the glass substrate web and a second compressive stress layer extending from the second surface into the bulk of the glass substrate web.

24-25. (canceled)

26. A system comprising:
a glass substrate web spool comprising:
a glass substrate web comprising a first surface and a second surface; and
a spacer layer applied to at least one of the first surface or the second surface, wherein the glass substrate web and the spacer layer are rolled into a spool such that a gap exists between the first surface and the second surface of the glass substrate web within the spool;
an enclosure; and
a fluid within the enclosure such that the fluid surrounds the glass substrate web and is disposed within the gap between the first surface and the second surface within the spool;
wherein the fluid comprises at least one of:
a chemical etchant solution operable to chemically etch the glass substrate web of the spool; or
an aqueous solution of silver nitrate operable to incorporate silver ions into the glass substrate web; or
an aqueous solution operable to exchange ions with the glass substrate web to form a first compressive stress layer extending from the first surface into a bulk of the glass substrate web and a second compressive stress layer extending from the second surface into the bulk of the glass substrate web.

27. (canceled)

28. The system of claim 26, wherein the fluid comprises the aqueous solution of silver nitrate operable to incorporate silver ions into the glass substrate web.
